(19) United States
(12) Patent Application Publication
(10) Pub. No.: US 2005/0197811 A1
(43) Pub. Date: Sep. 8, 2005

(54) Prediction of dynamic ground effect forces for fixed wing aircraft

(76) Inventor: Kartik B. Ariyur, Minnetonka, MN (US)

Correspondence Address: Matthew S. Luxton;Honeywell International, Inc., Law Dept. AB2, 101 Columbia Road, Morristown, NJ, 07962, US

(21) Appl. No.: 10/768,067

(22) Filed: Feb. 2, 2004

(51) Int. Cl. G06G 7/48

(52) U.S. Cl. 703/8

(57) ABSTRACT

Embodiments of the present invention relate to methods for calculating the aerodynamic forces and moments on fixed wing aircraft experiencing dynamic ground effects in subsonic flight. An airfoil and its trailing vortices are modeled as a lifting line with trailing vortex sheets and an image lifting line with trailing vortex sheets. The lifting line is located at a certain height above the ground and its image is located at an equal height below the ground, in order to satisfy a boundary condition of zero normal velocity at the ground. A downwash velocity at the airfoil is expressed as the sum of the downwash velocities from the lifting line and its image and is dependent on the height above the ground. The angle of attack of the airfoil is then expressed as a function its downwash velocity, the geometry of the airfoil, and a series representation of its vorticity distribution. The vorticity distribution is calculated from the angle of attack by numerical substitution. Aerodynamic forces and moments on the airfoil are calculated from the vorticity distribution. In another method, a lifting surface and image lifting surface are used to model an airfoil. These methods have particular use in autoland systems, autopilot systems and computer simulations.

### BACKGROUND OF THE INVENTION

1. Field of the Invention

Embodiments of the present invention relate to methods for predicting dynamic ground effect forces on fixed wing aircraft. More particularly, embodiments of the present invention relate to methods for calculating the aerodynamic forces and moments on fixed wing aircraft experiencing dynamic ground effects in subsonic flight. These calculations are suitable for use in aircraft rigid body simulations and in aircraft control systems, such as autopilot and autoland systems.

2. Background Information

Ground effects on aircraft have been observed and analyzed over several decades beginning almost from the inception of powered flight. Studies over this period have focused on the effects of aircraft maintaining a constant height near the ground. These theoretical and experimental studies have shown that lift increases, induced drag decreases and the pitching moment becomes nose-down on fixed-wing aircraft experiencing ground effects. In addition, drastic changes in ground effect forces on aircraft due to the rate of ascent or descent from the ground have been found experimentally and documented. Also, simple prediction models have been developed for ground effects. These models were motivated by linear aerodynamics and refined through experimentation.

Aerodynamic forces and moments on aircraft experiencing ground effects differ significantly from those experienced in high altitude flight. These forces and moments are experienced most often during take-off and landing. The experimental determination of these forces is expensive and time consuming. Dynamic ground effects are those effects experienced as the altitude of the aircraft is changing. These ground effects are difficult to achieve through wind tunnel testing. It is also hazardous to experiment with these effects through flight testing.

In view of the foregoing, it can be appreciated that a substantial need exists for methods that can advantageously predict aerodynamic forces and moments on aircraft as they increase or decrease altitude near the ground.

### BRIEF SUMMARY OF THE INVENTION

Embodiments of the present invention relate to methods for calculating the aerodynamic forces and moments on fixed wing aircraft experiencing dynamic ground effects in subsonic flight.

In one embodiment, an airfoil of a fixed wing aircraft and its trailing vortices are modeled as a lifting line with trailing vortex sheets at a certain height above the ground. In order to satisfy a boundary condition of zero normal velocity at the ground, an image lifting line with trailing vortex sheets is placed at a distance below the ground equal to the height above the ground. The downwash velocity at the airfoil is expressed as a sum of the downwash velocity obtained from trailing vortex sheets above the ground and a downwash velocity obtained from the image vortex sheets below the ground. The downwash velocity obtained from the image vortex sheets is a sum of two components. The first component is induced by the image vortex sheets. The second component accounts for the relative motion of the trailing sheets' vortices with respect to the lifting line and is, therefore, a function of the height above the ground and velocity of ascent or descent.

The angle of attack of the airfoil is then expressed as a function its downwash velocity, the geometry of the airfoil, and a series representation of its vorticity distribution. The geometry of the airfoil includes but is not limited to one or more of the wingspan, chord distribution, lift-slope, and twist distribution. The vorticity distribution is calculated from the angle of attack by substituting values for the angle of attack, a value for the height above the ground, a value of descent rate into the ground, and values for a geometry of the airfoil. Finally, aerodynamic forces and moments on the airfoil are calculated from the vorticity distribution. These aerodynamic forces include but are not limited to lift and drag. The aerodynamic moments include but are not limited to pitching moment.

In another embodiment a method for calculating dynamic ground effects of fixed wing aircraft in autoland systems, autopilot systems, or computer simulations is presented. An airfoil of the fixed wing aircraft and its trailing vortices are modeled as a lifting line with trailing vortex sheets at a certain height above the ground. The effects of interference from the ground on the trailing vortices is modeled as an image lifting line with trailing vortex sheets at a distance below the ground equal to the height above the ground. These two models are combined to create a model of the airfoil that is dependent on the height above the ground. Aerodynamic forces and moments are then calculated from this model. These aerodynamic forces include but are not limited to lift and drag. These moments include but are not limited to the pitching moment.

In a final embodiment, an airfoil and its trailing vortices are modeled as a lifting surface with vortex ring elements at a height above the ground. In order to satisfy a boundary condition of zero normal velocity at the ground, an image lifting surface with vortex ring elements are modeled at a distance below the ground equal to the height above the ground. The normal velocity induced by the vortex ring elements and the image vortex ring elements is calculated for a grid of points on the airfoil surface. A solution for the vorticity distribution is obtained by satisfying the boundary condition of zero normal velocity perpendicular to the wing surface. One or more of aerodynamic forces and moments on the airfoil are calculated from the vorticity distribution. These aerodynamic forces include but are not limited to lift and drag. The aerodynamic moments include but are not limited to pitching moment.

### BRIEF DESCRIPTION OF THE DRAWINGS

FIG. 1 is a schematic diagram depicting flow near an airfoil section in accordance with an embodiment of the present invention.

FIG. 2 is schematic diagram showing the lifting lines and vortex sheets for a vortex system and its image near the ground in accordance with an embodiment of the present invention.

FIG. 3 is a schematic diagram of the coordinate system for modified lifting line theory in accordance with an embodiment of the present invention.

FIG. 4 is a plot of the calculated relative increase in lift with decreasing height to wingspan ratios, increasing ascent angle, and decreasing descent angle in accordance with an embodiment of the present invention.

FIG. 5 is a plot of the calculated relative decrease in induced drag with decreasing height to wingspan ratios, increasing ascent angle, and decreasing descent angle in accordance with an embodiment of the present invention.

FIG. 6 is a schematic diagram showing the lifting surfaces and vortex rings for a vortex system and its image near the ground in accordance with an embodiment of the present invention.

FIG. 7 is a schematic diagram showing a wing panel element and a vortex ring element for a lifting surface solution in accordance with an embodiment of the present invention.

FIG. 8 is a schematic diagram showing the velocity induced by a three dimensional line vortex at a point in accordance with an embodiment of the present invention.

FIG. 9. is a flow chart of a method for calculating aerodynamic forces and moments on an airfoil using a modified lifting line and its image in accordance with an embodiment of the present invention.

FIG. 10 is a flow chart of a method for calculating aerodynamic forces and moments on an airfoil using a modified lifting line and its image used in autoland systems, autopilot systems or computer simulations in accordance with an embodiment of the present invention.

FIG. 11 is a flow chart of a method for calculating aerodynamic forces and moments on an airfoil using a lifting surface and its image in accordance with an embodiment of the present invention.

Before one or more embodiments of the invention are described in detail, one skilled in the art will appreciate that the invention is not limited in its application to the details of construction, the arrangements of components, and the arrangement of steps set forth in the following detailed description or illustrated in the drawings. The invention is capable of other embodiments and of being practiced or being carried out in various ways. Also, it is to be understood that the phraseology and terminology used herein is for the purpose of description and should not be regarded as limiting.

### DETAILED DESCRIPTION OF THE INVENTION

A map of aerodynamic forces throughout the flight envelope is needed to permit the design of safe autoland and autopilot systems. It is also needed to simulate aircraft performance under different conditions and to improve designs. The dynamic ground effects aircraft experience as they ascend from and descend to the ground are an important part of the flight envelope. As a result, a prediction model for dynamic ground effects is needed that is simple enough to be incorporated into the design of safe autoland and autopilot systems and computer simulations used in the design of aircraft.

According to an embodiment of the present invention, a method of calculating dynamic ground effects on fixed wing aircraft which extends Prandtl's lifting line theory by using an image vortex system with lifting line and vortex sheet under the ground to satisfy zero normal velocity at the ground is presented.

Modified Lifting Line Theory

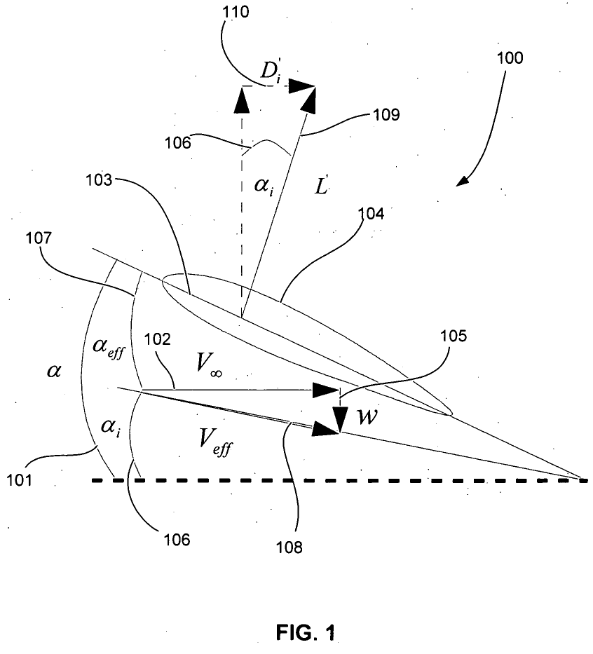

FIG. 1 is a schematic diagram depicting flow near an airfoil section in accordance with an embodiment of the present invention. α is angle of attack 101 at airfoil section 100, the angle between freestream flow 102 (V_{∞}) and chord line 103 of airfoil 104, and w is local downwash velocity 105 induced at the section by the. vortices trailing behind the wing. Induced angle of attack 106 (αᵢ) at section 100 is given by

$${α}_{i} = {tan}^{- 1} \frac{w}{{V}_{∞}} , \qquad ( 1.1 )$$

and effective angle of attack 107 between local resultant velocity 108 (V_{eff}) and airfoil 104, α_{eff} by
α_{eff}=α−αᵢ. (1.2)
This shifts local lift vector 109 (L′) by induced angle of attack 106 (αᵢ) at the section, creating a force component in the direction of the freestream. Induced drag 110 (Dᵢ) is then given by

$$\begin{matrix}{D}_{i} = {L}^{′} sin {α}_{i} \approx {L}^{′} {α}_{i} \\ = {L}^{′} \frac{w}{{V}_{∞}} .\end{matrix} \qquad ( 1.3 )$$

Prandtl's lifting line theory is based upon the assumption that the finite wing and its trailing vortices can be replaced by a lifting line with a trailing vortex sheet. The assumption is physically justified by the fact that there is a trailing vortex sheet behind an aircraft wing that rolls up into concentrated wing tip vortices a few chord lengths downstream of the wing. As most of the downwash at the wing is induced by vorticity in the near field, the assumption of a vortex sheet works well in practice. Furthermore, the vorticity introduced by a real wing into the freestream drops off to zero near its ends, and this fact is explicitly built into lifting line theory: a bound vortex (a vortex bound to a fixed location in space) with vortex strength Γ experiences a force L′=ρ_{∞}V_{∞}Γ in a freestream with velocity V_{∞} and density ρ_{∞} from the Kutta-Joukowski theorem; thus there will be no force distribution beyond the ends of the bound vortex.

When the separation between the wing and the ground is less than its span, the trailing vortices behind the wing are not permitted to develop fully due to interference from the ground, resulting in a reduction of the local vortex induced downwash w at the airfoil (the component of vortex induced velocity perpendicular to the freestream velocity V_{∞}). This effect is modeled as an image vortex system an equal height below the ground to satisfy the condition of zero normal velocity at the ground. This construct of images is standard in ideal fluid mechanics, and also in other systems where the field is governed by Laplace's equation, such as electrostatics. The idea is simply that of replacing the boundary condition by a suitable field.

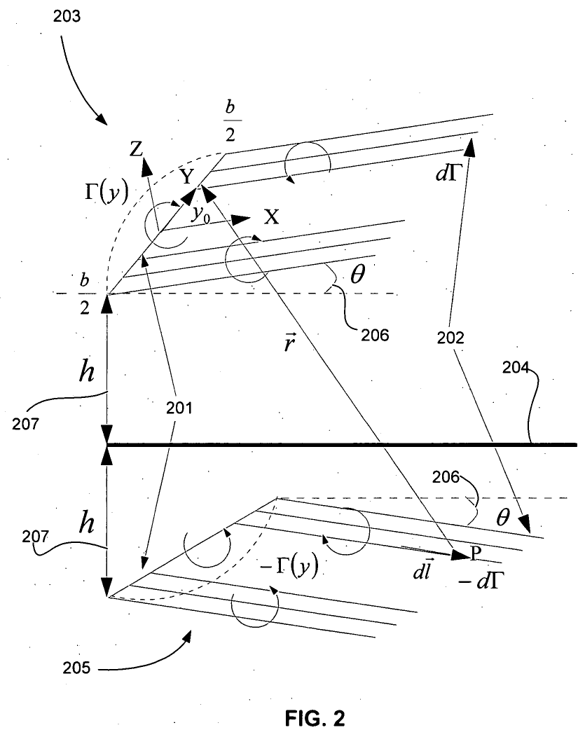

FIG. 2 is schematic diagram showing the lifting lines and vortex sheets for a vortex system and its image near the ground in accordance with an embodiment of the present invention. Lifting lines 201 and vortex sheets 202 are shown for vortex system 203 above ground 204 and image vortex system 205 below ground 204. An important point to note here is that vortex sheets 202 (as also the coordinate frame XYZ in FIG. 2) are inclined to the horizontal at angle of inclination 206 of the aircraft's velocity vector with the ground plane θ. This yields the vertical component of velocity with respect to the ground plane.
h=−V_{∞} sin θ≈−V_{∞}θ, (1.4)
where h is height 207 of the airplane above ground 204, and the approximation holds as the angle of approach of an aircraft to the ground is very small (<3°). FIG. 2 also gives an idea of the vorticity distribution Γ(y) across the wingspan of length b (lifting line) from

$$- \frac{b}{2}$$

to

$$\frac{b}{2} .$$

The vorticity distributions Γ(y) on the lifting line (bound vortex corresponding to the wing) and −Γ(y) in the image vortex system are of opposite sign to yield cancellation at ground level of the components of their induced velocities perpendicular to the ground. The downwash w at the lifting line (this is the Z -component of velocity induced at the lifting line by the trailing vortices and the image vortex system) is then expressed as the sum of contributions from the trailing vortex sheet (w_{T}) and the image vortex system wₗ:
w=w_{T}+wₗ. (1.5)

Now, the contribution from the image vortex has two components: the velocity wₗᵥ induced by the image vortex at the lifting line, and the component to account for relative motion of the image trailing vortices with respect to the lifting line. Hence, the contribution from the image vortex system is written as
wₗ=wₗᵥ+h cos θ≈wₗᵥ+h. (1.6)

Note that, in Eqn. (1.6), h<0 during descent, and h>0 during ascent. Thus, the dynamic effect adds to the downwash during descent and subtracts from it during ascent. The induced angle of attack is now expressed at a location y₀ on the lifting line (as in FIG. 2) as follows:

$$\begin{matrix}{α}_{i} = - {tan}^{- 1} \{ \frac{{w}_{T} + {w}_{lv} + \dot{h} cos θ}{{V}_{∞}} \} \\ = {tan}^{- 1} \{ \frac{- {w}_{T} - {w}_{lv}}{{V}_{∞}} + \frac{sin 2 θ}{2} \} ,\end{matrix} \qquad ( 1.7 )$$

substituting for h from Eqn. (1.4) and using the trigonometric identity 2 sin θ cos θ=sin 2θ. Results from airfoil theory are then used to relate the effective angle of attack α_{eff}(y₀) to the lift of the section. First, the lift coefficient at the section is given by

$$\begin{matrix}{c}_{l} = {c}_{l}^{α} [ {α}_{eff} ( {y}_{0} ) - {α}_{0} ( {y}_{0} ) ] , & ( 1.8 ) \\ {c}_{l}^{α} ≡ \frac{\partial {c}_{l}}{\partial α} , {α}_{0} ( {y}_{0} ) ≡ α ( {y}_{0} ) {\vert}_{L = 0} , & ( 1.9 )\end{matrix}$$

where the lift-slope cₗ^{α}=2π for an ideal airfoil, and α₀(y₀) takes into account the fact that the angle for zero lift is non-zero for non-symmetric airfoil sections. Using the definition of the lift coefficient

$$L = \frac{1}{2} {ρ}_{∞} {V}_{∞}^{2} c ( {y}_{0} ) {c}_{l} , \qquad ( 1.10 )$$

where c(y₀) is the chord length at y₀, and the Kutta-Joukowski expression for lift at the section
L=ρ_{∞}V_{∞}Γ(y₀), (1.11)
results in the following expression for the section lift coefficient in terms of the local circulation:

$${c}_{l} = \frac{2 Γ ( {y}_{0} )}{{V}_{∞} c ( {y}_{0} )} . \qquad ( 1.12 )$$

Finally, equating the expressions for cₗ from Eqn. (1.8) and Eqn. (1.12), produces the following relationship between the nominal angle of attack and the effective angle at the position y₀ on the lifting line:

$${α}_{eff} ( {y}_{0} ) - {α}_{0} ( {y}_{0} ) = \frac{2 Γ ( {y}_{0} )}{{c}_{l}^{α} {V}_{∞} c ( {y}_{0} )} , \qquad ( 1.13 )$$

which, on substitution for α_{eff} from Eqn. (1.2) and for αᵢ from Eqn. (1.7) yields

$$α ( {y}_{0} ) = {α}_{0} ( {y}_{0} ) + \frac{2 Γ ( {y}_{0} )}{{c}_{l}^{α} {V}_{∞} c ( {y}_{0} )} + {tan}^{- 1} \{ \frac{- {w}_{T} - {w}_{lv}}{{V}_{∞}} + \frac{sin 2 θ}{2} \} , \qquad ( 1.14 )$$

which is an equation to be solved for the vorticity distribution Γ(y) using the known distribution of the angle of attack α(y) (this depends upon wing twist) and chord distribution c(y) along the wingspan. The explicit expressions for the vortex-induced velocities w_{T} and wₗᵥ are derived in terms of the vorticity distribution Γ(y).

The Biot-Savart law gives the velocity d\vec{V} induced by a vortex segment d\vec{l} with vorticity Γ at a distance \vec{r} from it as

$$d {V}^{->} = \frac{Γ}{4 π} \frac{d {l}^{->} \times {r}^{->}}{{\vert {r}^{->} \vert}^{3}} . \qquad ( 1.15 )$$

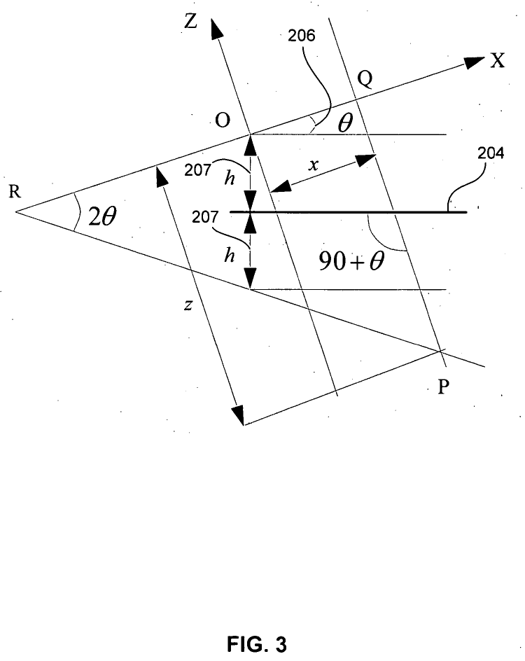

Before calculating w_{T} and wₗᵥ the coordinate system for calculation of the position vector \vec{r} is established for both the lifting line vortex system and its image. FIG. 3 is a schematic diagram of the coordinate system for modified lifting line theory in accordance with an embodiment of the present invention. This figure details the coordinate system already shown in FIG. 2. h is height 207 of the lifting line above ground 204, and therefore, of its image below the ground. Angle 206 (θ) is the inclination of the trailing vortex system from the horizontal. This is equivalent to the aircraft in descent. The y-axis remains parallel to the ground and perpendicular to the plane of FIG. 3.
Lifting Line Contribution

Since the coordinates for the trailing vortex sheet behind the lifting line relative to the airplane are the same as in lifting line theory, its contribution to velocity induced at the lifting line remains the same as in lifting line theory: a downwash velocity induced at y₀ given by

$${w}_{T} ( {y}_{o} ) = - \frac{1}{4 π} {\int }_{- \frac{b}{2}}^{\frac{b}{2}} \frac{ⅆ Γ / ⅆ y}{{y}_{0} - y} ⅆ y , \qquad ( 1.16 )$$

where the integral is over the wingspan to account for the effect of the entire trailing vortex sheet at the point y₀. The calculations are familiar to those skilled in the art. The detailed calculations for the image vortex system are presented below.
Image Vortex Contribution

In order to determine the velocity induced by a segment of the image vortex at the lifting line, the displacement vector \vec{r} (in FIG. 2) is expressed from point P on the image vortex system to a point a distance y₀ from the origin on the lifting line. As is clear from FIG. 2, the Z-coordinate is a function of both the. X-coordinate and the height of the lifting line from the ground. Consider the point P with X-coordinate x: to determine its Z coordinate z, basic trigonometry is applied to the triangle PQR. First, the side RQ is described as
RQ=RO+OQ=h/sin θ+x, (1.17)
and then the following relationship is obtained from triangle PQR:

$$PQ = R Q tan 2 θ ⇒ z = \frac{h tan 2 θ}{sin θ} + x tan 2 θ , \qquad ( 1.18 )$$

which results in
z=2h cos θ sec 2θ+x tan 2θ. (1.19)

The orientation vector of a vortex segment d\vec{l} at point P in FIG. 2 with strength −dΓ and its displacement vector \vec{r} to point y₀ on the lifting line is written as:
d\vec{l}=−dxêₓ+dx tan 2θê_{z} (1.20)
\vec{r}=−xêₓ+(y₀−y)\vec{e}_{y}+(2h cos θ sec 2θ+x tan 2θ)ê_{z}, (1.21)
where êₓ, ê_{y}, and ê_{z} are the unit vectors along the X, Y, and Z axes. From Eqn. (1.21), its Euclidean norm is calculated

$$\begin{matrix}\vert {r}^{->} \vert = [ {x}^{2} + {( {y}_{0} - y )}^{2} + \\ { {( 2 h cos θ sec 2 θ + x tan 2 θ )}^{2} ]}^{\frac{1}{2}} \\ = [ {sec}^{2} 2 θ {x}^{2} + 4 h cos θ sec 2 θ tan 2 θ x + {( {y}_{0} - y )}^{2} + \\ { 4 {h}^{2} {cos}^{2} θ {sec}^{2} 2 θ ]}^{\frac{1}{2}} \\ = sec 2 θ [ {x}^{2} + 4 h cos θsin2θ x + {( {y}_{0} - y )}^{2} {cos}^{2} 2 θ + \\ { 4 {h}^{2} {cos}^{2} θ ]}^{\frac{1}{2}} \\ = sec 2 θ [ {( x + 2 h cos θ sin 2 θ )}^{2} + {( {y}_{0} - y )}^{2} {cos}^{2} 2 θ + \\ { 4 {h}^{2} {cos}^{2} {θcos}^{2} 2 θ ]}^{\frac{1}{2}} ,\end{matrix} \qquad ( 1.22 )$$

where the simplifications have been performed using standard trigonometric identities. Now is d\vec{l}×\vec{r} can be calculated as
d\vec{l}×\vec{r}=−(y₀−y)tan 2θdxêₓ+((2h cos θ sec 2θ+x tan 2θ)−x tan 2θ)dxê_{y}−(y₀−y)dxê_{z}. (1.23)

Only the Z-component is considered in further analysis. This is because the X-component of velocity induced is a second order effect as it has a factor tan 2θ multiplying it. The Y-component of velocity induced slightly tilts the local velocity vector to point to a slightly different cross-section for an airfoil of finite thickness, locally changing the chord distribution; the effect is ignored because it is small and the difficulty of analysis is significantly increased by including it. It should be included in the analysis of very large wings. The contribution of the bound image vortex to the X and Z components of induced velocity are also neglected at the lifting line. The X-component is neglected because it is small compared to V_{∞}, and the Z-component is a second order effect, as it has a factor of sin θ inside. The upwash component dwₗᵥ induced by the semi-infinite vortex filament of strength −dΓ is now written using the Biot-Savart law in Eqn. (1.15).

$$\begin{matrix}d {w}_{lv} = \frac{( {y}_{o} - y ) d Γ}{4 π {sec}^{3} 2 θ} {\int }_{0}^{∞} \frac{dx}{\begin{matrix}[ {( x + 2 h cos θ sin 2 θ )}^{2} + {( {y}_{0} - y )}^{2} \\ {{cos}^{2} 2 θ + 4 {h}^{2} {cos}^{2 } {θcos}^{2} 2 θ ]}^{\frac{1}{2}}\end{matrix}} \\ = \frac{cos 2 θ}{4 π} \frac{( {y}_{0} - y ) d Γ}{[ {( {y}_{0} - y )}^{2} + 4 {h}^{2} {cos}^{2} θ ]} ,\end{matrix} \qquad ( 1.24 )$$

where the definite integral is evaluated through trigonometric substitution. The upwash velocity wₗᵥ induced by the image vortex system is the integral of dwₗᵥ over the lifting line and is therefore given by

$${w}_{lv} = \frac{cos 2 θ}{4 π} {\int }_{- \frac{b}{2}}^{\frac{b}{2}} \frac{( {y}_{0} - y ) ⅆ Γ / ⅆ y}{[ {( {y}_{0} - y )}^{2} + 4 {h}^{2} {cos}^{2} θ ]} ⅆ y . \qquad ( 1.25 )$$

Modified Lifting Line Equation

Substituting Eqns. (1.16) and (1.25) into Eqn. (1.14), yields

$$α ( {y}_{0} ) = {α}_{0} ( {y}_{0} ) + \frac{2 Γ ( {y}_{0} )}{{c}_{l}^{α} {V}_{∞} c ( {y}_{0} )} + {tan}^{- 1} \{ \frac{1}{4 π {V}_{∞}} {\int }_{- \frac{b}{2}}^{\frac{b}{2}} \frac{ⅆ Γ / ⅆ y}{{y}_{0} - y} ⅆ y - \frac{cos 2 θ}{4 π {V}_{∞}} {\int }_{- \frac{b}{2}}^{\frac{b}{2}} \frac{( {y}_{0} - y ) ⅆ Γ / ⅆ y}{[ {( {y}_{0} - y )}^{2} + 4 {h}^{2} {cos}^{2} θ ]} ⅆ y + \frac{sin 2 θ}{2} \} , \qquad ( 1.26 )$$

where θ is positive for descent and negative for ascent. Two further simplifications can be made: first, if θ was assumed to be very small (sin θ≈θ, cos θ≈1), Eqn. (1.26) can be rewritten as

$$α ( {y}_{0} ) = {α}_{0} ( {y}_{0} ) + \frac{2 Γ ( {y}_{0} )}{{c}_{l}^{α} {V}_{∞} c ( {y}_{0} )} + {tan}^{- 1} \{ \frac{1}{4 π {V}_{∞}} {\int }_{- \frac{b}{2}}^{\frac{b}{2}} \frac{ⅆ Γ / ⅆ y}{{y}_{0} - y} ⅆ y - \frac{1}{4 π {V}_{∞}} {\int }_{- \frac{b}{2}}^{\frac{b}{2}} \frac{( {y}_{0} - y ) ⅆ Γ / ⅆ y}{[ {( {y}_{0} - y )}^{2} + 4 {h}^{2} ]} ⅆ y + θ \} \qquad ( 1.27 )$$

Secondly, if the induced angle of attack is small, the arctangent can be replaced with its argument:

$$α ( {y}_{0} ) = {α}_{0} ( {y}_{0} ) + \frac{2 Γ ( {y}_{0} )}{{c}_{l}^{α} {V}_{∞} c ( {y}_{0} )} + \frac{1}{4 π {V}_{∞}} {\int }_{- \frac{b}{2}}^{\frac{b}{2}} \frac{ⅆ Γ / ⅆ y}{{y}_{0} - y} ⅆ y - \frac{1}{4 π {V}_{∞}} {\int }_{- \frac{b}{2}}^{\frac{b}{2}} \frac{( {y}_{0} - y ) ⅆ Γ / ⅆ y}{[ {( {y}_{0} - y )}^{2} + 4 {h}^{2} ]} ⅆ y + θ . \qquad ( 1.28 )$$

Eqn. (1.28) has two additional terms besides the usual terms in lifting line theory. The first is the upwash term introduced by the image vortex that appears as the second integral in the right hand side; the second term is due to a non-constant height, the angle θ, which is the angle of the aircraft velocity vector with the ground plane, with sign reversed. Clearly, if h→∞, and θ=0, the equation reverts to the familiar form of Prandtl's lifting line equation. Any one of Equations (1.26), (1.27), or (1.28) can be solved to yield the distribution of circulation over the lifting line Γ(y).

Solution Procedure

To facilitate systematic solution of the integro-differential Eqn. (1.26) or its simplified versions in Eqns. (1.27), or (1.28), the following substitutions are made, which are standard for solving the lifting line equation:

$$\begin{matrix}y = - \frac{b}{2} cos ϕ & ( 1.29 ) \\ Γ ( ϕ ) = 2 b {V}_{∞} {\sum }_{n = 1}^{N} {A}_{n} sin n ϕ , & ( 1.30 )\end{matrix}$$

where the representation for Γ(φ) ensures that the vorticity vanishes at the ends of the lifting line (wingspan). Using the above coordinate change, the derivative dΓ/dy used in the integrals is calculated as:

$$\begin{matrix}\begin{matrix}\frac{ⅆ Γ ( ϕ )}{ⅆ y} = \frac{ⅆ Γ}{ⅆ ϕ} \frac{ⅆ ϕ}{ⅆ y} \\ = 2 {bV}_{∞} {\sum }_{n = 1}^{N} n {A}_{n} cos n ϕ \frac{ⅆ ϕ}{ⅆ y}\end{matrix} & ( 1.31 ) \\ \frac{ⅆ ϕ}{ⅆ y} = \frac{2}{b sin ϕ} . & ( 1.32 )\end{matrix}$$

Writing the modified lifting line equation (Eqn.(1.26)) in the new coordinates:

$$α ( {ϕ}_{0} ) = {α}_{0} ( {ϕ}_{0} ) + \frac{4 b}{{c}_{l}^{α} c ( {ϕ}_{0} )} {\sum }_{n = 1}^{N} {A}_{n} sin n {ϕ}_{0} + {tan}^{- 1} \{ \frac{1}{π} {\int }_{0}^{π} \frac{{\sum }_{n = 1}^{N} n {A}_{n} cos n ϕ }{cos ϕ - cos {ϕ}_{0}} ⅆ ϕ - \frac{cos 2 θ}{π} {\int }_{0}^{π} \frac{( cos ϕ - cos {ϕ}_{0} ) {\sum }_{n = 1}^{N} n {A}_{n} cos n ϕ}{[ {( cos ϕ - cos {ϕ}_{0} )}^{2} + 16 {( \frac{h}{b} )}^{2} {cos}^{2} θ ]} ⅆ ϕ + \frac{sin 2 θ}{2} \} . \qquad ( 1.33 )$$

A further simplification of the calculation is obtained by using the substitute for the Glauert integral,

$${\int }_{0}^{π} \frac{cos n ϕ}{cos ϕ - cos {ϕ}_{0}} ⅆ ϕ = \frac{π sin n {ϕ}_{0}}{sin {ϕ}_{0}} , \qquad ( 1.34 )$$

in Eqn. (1.33) to get:

$$α ( {ϕ}_{0} ) = {α}_{0} ( {ϕ}_{0} ) + \frac{4 b}{{c}_{l}^{α} c ( {ϕ}_{0} )} {\sum }_{n = 1}^{N} {A}_{n} sin n {ϕ}_{0} + {tan}^{- 1} \{ {\sum }_{n = 1}^{N} n {A}_{n} \frac{sin n {ϕ}_{0}}{sin {ϕ}_{0}} - \frac{cos 2 θ}{π} {\int }_{0}^{π} \frac{( cos ϕ - cos {ϕ}_{0} ) {\sum }_{n = 1}^{N} n {A}_{n} cos n ϕ }{[ {( cos ϕ - cos {ϕ}_{0} )}^{2} + 16 {( \frac{h}{b} )}^{2} {cos}^{2} θ ]} ⅆ ϕ + \frac{sin 2 θ}{2} \} . \qquad ( 1.35 )$$

Eqn. (1.35) can be simplified assuming θ small (in effect cos 2θ≈1, cos θ≈1, sin 2θ≈2θ) and by approximating the arctangent by its argument to yield

$$α ( {ϕ}_{0} ) = {α}_{0} ( {ϕ}_{0} ) + \frac{4 b}{{c}_{l}^{α} c ( {ϕ}_{0} )} {\sum }_{n = 1}^{N} {A}_{n} sin n {ϕ}_{0} + {\sum }_{n = 1}^{N} n {A}_{n} \frac{sin n {ϕ}_{0}}{sin {ϕ}_{0}} - \frac{1}{π} {\int }_{0}^{π} \frac{( cos ϕ - cos {ϕ}_{0} ) {\sum }_{n = 1}^{N} n {A}_{n} cos n ϕ}{[ {( cos ϕ - cos {ϕ}_{0} )}^{2} + 16 {( \frac{h}{b} )}^{2} ]} ⅆ ϕ + θ . \qquad ( 1.36 )$$

The additional integral term introduced by ground effect yields a very lengthy and complicated solution without directly showing physical significance. Hence, it is not presented here. Instead numerical integration is used in the calculations. A solution for n terms in the series for Γ(φ) can be found using values of angle of attack, and chord at n locations along the wingspan to yield a linear system of equations for the Aₙ, n=1 . . . N for each distribution of commanded angle of attack α(y) along the wing, and parameterized by the height from the ground h, and the angle θ made by −V_{∞}with the ground. The linear system of equations is written as follows:

$$\begin{matrix}X ( {Φ}_{0} ) ( \begin{matrix}{A}_{1} ( 22 ) \\ {A}_{2} ( 23 ) \\ ⋮ ( 24 ) \\ {A}_{N}\end{matrix} ) = ( \begin{matrix}α ( {ϕ}_{01} ) - {α}_{0} ( {ϕ}_{01} ) - θ ( 25 ) \\ α ( {ϕ}_{02} ) - {α}_{0} ( {ϕ}_{02} ) - θ ( 26 ) \\ ⋮ ( 27 ) \\ α ( {ϕ}_{0 N} ) - {α}_{0} ( {ϕ}_{0 N} ) - θ ( 28 )\end{matrix} ) \\ {Φ}_{0} = {[ \begin{matrix}{ϕ}_{01} & {ϕ}_{02} & … & {ϕ}_{0 N}\end{matrix} ]}^{T} ,\end{matrix} \qquad ( 1.37 )$$

where the elements Xᵢⱼ(φ₀ᵢ) of X(Φ₀) are given by

$${X}_{ij} ( {ϕ}_{0 i} ) = \frac{4 b sin {jϕ}_{0 i}}{{c}_{l}^{α} c ( {ϕ}_{0 i} )} + j \frac{sin {jϕ}_{0 i}}{sin {ϕ}_{0 i}} - \frac{1}{π} {\int }_{0}^{π} \frac{j ( cos ϕ - cos {ϕ}_{0 i} ) cos jϕ }{[ {( cos ϕ - cos {ϕ}_{0 i} )}^{2} + 16 {( \frac{h}{b} )}^{2} ]} ⅆ ϕ . \qquad ( 1.38 )$$

Lift, Drag, and Pitch Moment Calculations

Once the distribution of circulation Γ(φ) over the wingspan has been calculated, the calculations of lift and drag are straightforward:

$$\begin{matrix}{L}_{IGE} = {\int }_{- b / 2}^{b / 2} {L}^{′} ( y ) ⅆ y \\ = {\int }_{- b / 2}^{b / 2} {ρ}_{∞} {V}_{∞} Γ ( y ) ⅆ y \\ = \frac{{ρ}_{∞} {V}_{∞} b}{2} {\int }_{0}^{π} Γ ( ϕ ) sin ϕ ⅆ ϕ \\ = {ρ}_{∞} {V}_{∞}^{2} {b}^{2} {\int }_{0}^{π} {\sum }_{n = 1}^{N} {A}_{n} sin n ϕsin ϕ ⅆ ϕ \\ = \frac{{ρ}_{∞} {V}_{∞}^{2} {b}^{2} π {A}_{1}}{2} ,\end{matrix} \qquad ( 2.1 )$$

where the series representation for Γ(φ) from Eqn. (1.30) is used and the transformed integration over the span is used to integrate over φ using Eqn. (1.29). All products other than sin² φ inside the integral integrate to zero. The calculation of drag is more involved. It is obtained through integrating the distribution of local drag Dᵢ obtained in Eqn (1.3):

$$\begin{matrix}\begin{matrix}{D}_{i} ( y ) = {L}^{′} ( y ) {α}_{i} ( y ) \\ = {ρ}_{∞} {V}_{∞} Γ ( y ) {α}_{i} ( y )\end{matrix} & ( 2.2 ) \\ \begin{matrix}{D}_{iIGE} = {\int }_{- b / 2}^{b / 2} {D}_{i} ( y ) ⅆ y \\ = {\int }_{- b / 2}^{b / 2} {ρ}_{∞} {V}_{∞} Γ ( y ) {α}_{i} ( y ) ⅆ y \\ = \frac{{ρ}_{∞} {V}_{∞} b}{2} {\int }_{0}^{π} Γ ( ϕ ) {α}_{i} ( ϕ ) sin ϕ ⅆ ϕ\end{matrix} & ( 2.3 ) \\ \begin{matrix}{α}_{i} ( ϕ ) = {\sum }_{n = 1}^{N} n {A}_{n} \frac{sin n ϕ}{sin ϕ} - \\ \frac{1}{π} {\int }_{0}^{π} \frac{( cos η - cos ϕ ) {\sum }_{n = 1}^{N} n {A}_{n} cos n η}{[ {( cos η - cos ϕ )}^{2} + 16 {( \frac{h}{b} )}^{2} ]} ⅆ η + θ \\ = α ( ϕ ) - {α}_{0} ( ϕ ) - \frac{4 b}{{c}_{l}^{α} c ( ϕ )} {\sum }_{n = 1}^{N} {A}_{n} sin n ϕ ,\end{matrix} & ( 2.4 )\end{matrix}$$

where αᵢ(φ) uses the series representation for Γ(φ), and where a substitution is made for αᵢ the modified lifting line equation, Eqn. (1.36), to avoid numerical evaluation of a double integral.

To calculate the ground effect contribution to lift and drag, the basic lifting line equation is solved out of ground effect,

$$α ( {ϕ}_{0} ) = {α}_{0} ( {ϕ}_{0} ) + \frac{4 b}{{c}_{l}^{α} c ( {ϕ}_{0} )} {\sum }_{n = 1}^{N} {B}_{n} sin n {ϕ}_{0} + {\sum }_{n = 1}^{N} {nB}_{n} \frac{sin n {ϕ}_{0}}{sin {ϕ}_{0}} , \qquad ( 2.5 )$$

for B₁, . . . , B_{N}, and calculate lift L_{OGE} and induced drag D_{iOGE} out of ground effect as before. The difference between the quantities in and out of ground effect yields the ground effect contribution. The pitching moment due to ground effect can be estimated from an approximate calculation using the dependence of the moment coefficient upon angle of attack and flap deflection angle:

$$\begin{matrix}\begin{matrix}{C}_{m} = {C}_{m} αα + {C}_{m} δδ , {C}_{m} α \\ = \frac{\partial {C}_{m}}{\partial α} , {C}_{m} δ \\ = \frac{\partial {C}_{m}}{\partial δ}\end{matrix} & ( 2.6 ) \\ \begin{matrix} = \frac{\partial {C}_{m}}{\partial {C}_{l} {c}_{l}^{α} α} + \frac{\partial {C}_{m}}{\partial {C}_{l} {c}_{l}^{δ} δ} , {c}_{l}^{δ} \\ = \frac{\partial {C}_{l}}{\partial δ} .\end{matrix} & ( 2.7 )\end{matrix}$$

In addition, the change in α_{eff} due to ground effect is calculated:

$$\begin{matrix}{Δα}_{eff} ( ϕ ) = \frac{2}{{c}_{l}^{α} {V}_{∞} c ( ϕ )} ( {Γ}_{IGE} ( ϕ ) - {Γ}_{OGE} ( ϕ ) ) \\ = \frac{4 b}{{c}_{l}^{α} c ( ϕ )} {\sum }_{n = 1}^{N} ( {A}_{n} - {B}_{n} ) sin n ϕ ,\end{matrix} \qquad ( 2.8 )$$

which can be substituted into Eqn. (2.7) to yield ΔCₘ(φ):

$$Δ {C}_{m} ( ϕ ) \approx \frac{\partial {C}_{m}}{\partial {C}_{l}} {c}_{l}^{α} {Δα}_{eff} ( ϕ ) + \frac{\partial {C}_{m}}{\partial {C}_{l}} {c}_{l}^{δ} {Δα}_{eff} ( ϕ ) , \qquad ( 2.9 )$$

where it is assumed that the change in effective angle of attack due to vortex induced velocity is the same for the flaps/ailerons. Finally, using the definition of the section moment coefficient Cₘ(y)=2M′(y)/(ρ₂₈ V₂₈ ²c(y)²), where M′(y) is the section moment, integration is performed to estimate the change in moment under ground effect as

$$Δ M = \frac{b {ρ}_{∞} {V}_{∞}^{2}}{4} {\int }_{0}^{π} Δ {C}_{m} ( ϕ ) {c ( ϕ )}^{2} sin ϕ ⅆ ϕ , \qquad ( 2.10 )$$

where a substitution for y from Eqn. (1.29) has been used.
Forces on Control Surfaces

To estimate the forces and moments on the tail plane, the horseshoe vortex equivalent of the lifting line vortex system and its image is calculated first. This is obtained by equating the lift in ground effect to that produced by a single equivalent vortex with vorticity Γ₀ equal to that at midspan φ=π2. Thus,

$$\begin{matrix}{L}_{IGE} = {ρ}_{∞} {V}_{∞} Γ ( π / 2 ) {b}_{red} \\ = \frac{{ρ}_{∞} {V}_{∞}^{2} {b}^{2} π {A}_{1}}{2} ,\end{matrix} \qquad ( 2.11 )$$

from which the approximate vortex separation b_{red} is derived as

$${b}_{red} = \frac{{V}_{∞} {b}^{2} π {A}_{1}}{2 Γ ( π / 2 )} . \qquad ( 2.12 )$$

The downwash at the tailplane location is estimated using the equivalent vortices and their images. This in turn is used to calculate effective angle of attack distribution at the tail and thus the lift, drag, and moments due to ground effect.

Crosswind

A crosswind inclines the freestream velocity vector so as to change effective airfoil section facing the wind, thus changing the lift slope cₗ^{α}. For greater accuracy in this calculation, the Y-component of velocity induced by the image vortices is included. This gives a distribution of the y-component of velocity at the lifting. line, which implies a distribution in effective aerodynamic chord and lift-slope. The performance of this calculation provides good full-scale estimates of aircraft forces in a crosswind. This is beneficial, considering that experimental measurement with an aircraft is dangerous and difficult. It is also difficult to simulate dynamic ground effect in wind tunnel experiments.

Wake Vortices

Additional downwash/upwash terms introduced by these vortices can be introduced into Eqn. (1.5), which in turn lead to additional terms in the modified lifting line equation (Eqn. (1.26)), which are solved by the same procedure. The strength of wake vortices generated by different aircraft can be estimated by methods in an FAA report on aircraft wake vortices.

Calculation for the Gulfstream V

The dynamic ground effects on the Gulfstream V were estimated assuming an untwisted wing, elliptic chord distribution c(φ)=cₘₐₓ sin φ, and uniform ideal lift-slope cₗ^{α}=2π. The wingspan used was b=27.69 m. The maximum chord distribution was estimated to be cₘₐₓ=3.814 m by approximating both wing halves as triangles with chord as base and semi-wingspan as height. The velocity V_{∞}=67 m/sec (150 mph) was used for the calculation. For the numerical solution of Eqn. (1.36), the values of φ₀=π/20,2π/20, . . . , 18π20 were used to solve it in matrix form (as in Eqn. (1.37)). The coefficients B₁, . . . , B_{N} out of ground effect were obtained by solving Eqn. (2.5). The coefficients A₁, . . . , A_{N} in ground effect were obtained by solving Eqn. (1.36) for a range of height to span ratios h/b=0.05, 0.15, 0.25, . . . , 0.95, and for a range of descent/ascent angle θ=−0.03, −0.02, . . . , 0.03 rad.

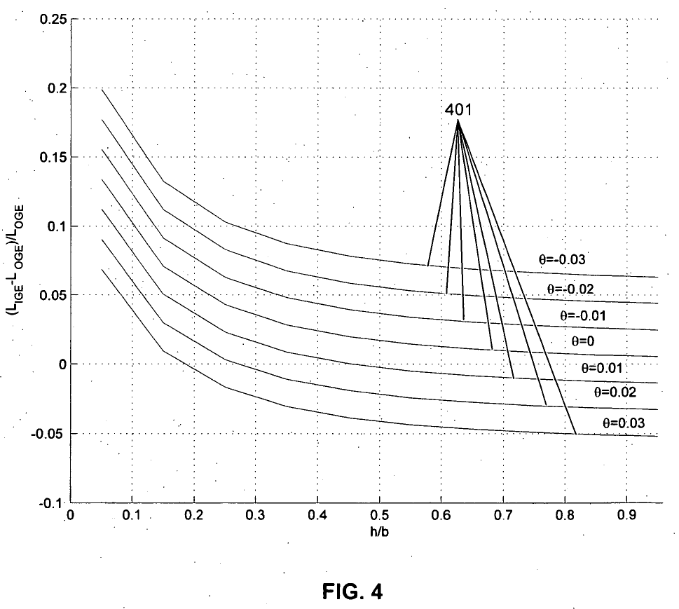

FIG. 4 is a plot of the calculated relative increase in lift with decreasing height to wingspan ratios, increasing ascent angle, and decreasing descent angle in accordance with an embodiment of the present invention. Calculated relative lift curves 401

$$( \frac{{L}_{IGE} - {L}_{OGE}}{{I}_{OGE}} )$$

are shown for ascent (negative θ) and descent (positive θ) angles.

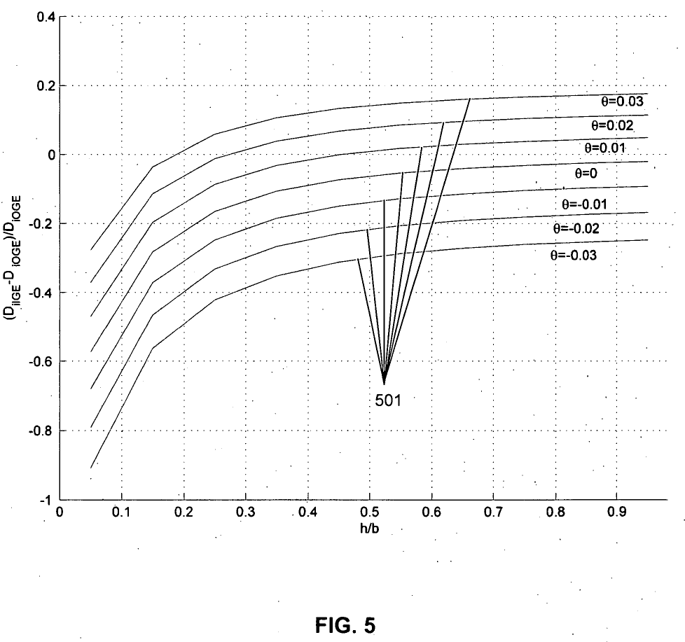

FIG. 5 is a plot of the calculated relative decrease in induced drag with decreasing height to wingspan ratios, increasing ascent angle, and decreasing descent angle in accordance with an embodiment of the present invention. Calculated relative induced drag curves 501

$$( \frac{{D}_{iIGE} - {D}_{iOGE}}{{D}_{iOGE}} )$$

are shown for ascent (negative θ) and descent (positive θ) angles.

Exemplary programs for the calculations shown in FIGS. 4 and 5 have been written in MATLAB™. These calculations show an increase of lift and a reduction of induced drag in ground effect, the greatest benefits being attained closest to the ground. The dynamic effect reduces the ground effect lift and increases ground effect drag for descent with increasing descent angle. In ascent, ground effect lift increases and ground effect drag decreases with increasing ascent angle. The variation of the forces with θ is linear.

The above calculations can be performed for high angles of attack using nonlinear lifting line theory provided an experimental lift-angle of attack curve is available. Similarly, if Cₘ^{α} and Cₘ^{δ} are known, the pitching moment in ground effect can be estimated. The entire work can be easily extended to formulate and solve a modified lifting surface theory that would supply more accurate estimates of ground effect forces and moments and also permit calculation of forces and moments due to flap and actuator deflections. The solution procedure for lifting surface theory for constant altitude ground effect can be easily generalized to incorporate dynamic ground effects.

Generalization to Lifting Surfaces

The entire calculation performed in the previous sections can be generalized to lifting surfaces to yield more accurate estimates of lift and drag, and a precise calculation of the pitching moment. The integro-differential equations that arise can be solved through the vortex lattice method. For greater accuracy, the lifting surface with vortex ring elements can be directly modeled and made to satisfy the boundary conditions exactly on the curved surface of the wing. Moreover, the solution can easily be generalized to unsteady flow. Similar calculations can be performed for the tail plane also as lifting surface theory is applicable to small aspect ratio wings. Further, this generalization permits the calculation of ground effect forces for aircraft with small aspect ratio wings, which includes most fighter aircraft.

Coordinate System for the Lifting Surface

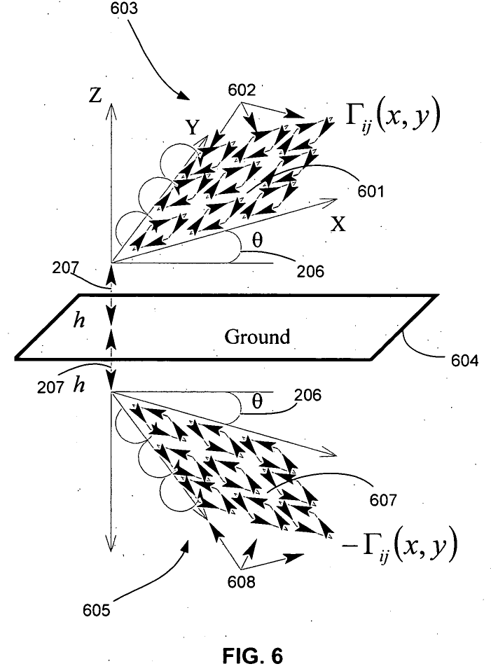

FIG. 6 is a schematic diagram showing the lifting surfaces and vortex rings for a vortex system and its image near the ground in accordance with an embodiment of the present invention. Lifting surface 601 of vortex system 603 is shown above ground surface 604 at height 207 angle 206. Lifting surface 601 contains vortex ring elements 602. Lifting surface 607 of image vortex system 605 is shown below ground surface 604 at height 207 and angle 206. Lifting surface 607 contains vortex ring elements 608.

As with the lifting line theory, the coordinate system is fixed to the aircraft wing. The difference with lifting surfaces is that there is a variation of circulation Γ(x,y) both with x and y. In the wake, the circulation Γ_{Wake}(y) becomes a function of y. Here too, the image lifting surface has opposite sign for its vorticity. This exactly cancels the normal velocity induced by the wing lifting surface at the ground. Using the Biot law, Eqn. (1.15), the downwash induced by the vortex ring elements is calculated both in the wing lifting surface and in the image lifting surface on a grid of points on the wing surface. A solution for the vorticity distribution is obtained by satisfying the boundary condition of zero normal velocity perpendicular to the wing surface.

Numerical Solution

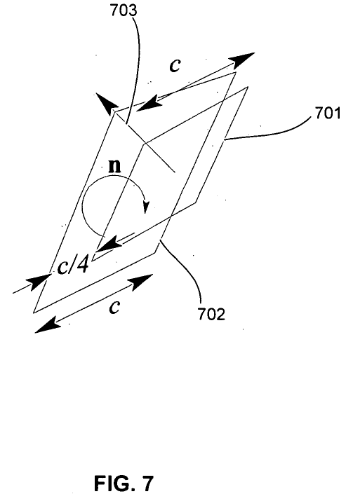

FIG. 7 is a schematic diagram showing a wing panel element and a vortex ring element for a lifting surface solution in accordance with an embodiment of the present invention. The grid is defined by discretizing the wing surface into rectangular panel elements on the wing surface (this surface can be curved to account for wing camber and curvature) and position the vortex rings with respect to the panels as shown in FIG. 6. The leading segment of vortex ring element 701 is placed on quarter chord line of wing panel 702, and the collocation point is at the center of the three-quarter chord line. Normal vector 703(n) is defined at this point as well (it is the center of vortex ring element 701). The wake vortices are set up so as to cancel the vorticity at the trailing edge of the wing/lifting surface, i.e., Γ_{T.E}=Γ_{Wake} for each of the vortex ring elements on the trailing edge. The normal velocity induced by the vortex rings (in both the wing system and the image system) at each of the collocation points is calculated using the Biot-Savart law (Eqn. (1.15)) and equated to the normal component of the freestream velocity at those points.

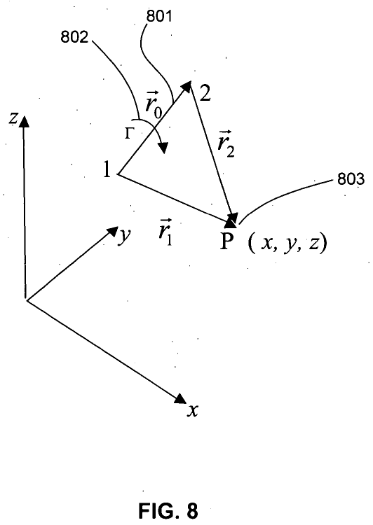

FIG. 8 is a schematic diagram showing the velocity induced by a three dimensional line vortex at a point in accordance with an embodiment of the present invention. The vorticity induced by a vortex ring is calculated by summing the velocities induced by its four edges. Each of these velocities is calculated using the following formula for the velocity induced by a three dimensional line vortex 801 of strength 802 (Γ) at a point 803 (P):

$${\vec{V}}_{12} = \frac{Γ}{4 π} ( {\vec{r}}_{0} \cdot ( \frac{{\vec{r}}_{1}}{\vert {\vec{r}}_{1} \vert} - \frac{{\vec{r}}_{2}}{\vert {\vec{r}}_{2} \vert} ) ) \frac{{\vec{r}}_{1} \times {\vec{r}}_{2}}{{\vert {\vec{r}}_{1} \times {\vec{r}}_{2} \vert}^{2}} , \qquad ( 4.1 )$$

where the notation is supplied in FIG. 8.

This calculation naturally includes the effect of sink/rise rates if the image vortex system is moving with respect to the wing system (as with the lifting line calculation, the relative velocities will add to the vortex induced velocities). After obtaining the vorticity distribution, the induced lift and induced drag contributions due to each of the panels is obtained. The steps of computation are identical to those known in the art (though the mathematical formulation and results are different for the case of dynamic ground effect), except for the fact that if there is a non-zero roll angle, the symmetry of the vorticity distribution over the left and right halves of the wing surface cannot be used. Finally, in the case of unsteady flight, the evolving kinemetic components are used to get a satisfactory calculation of lift, and a satisfactory calculation of induced drag when the direction of flight velocity does not change (though the aircraft may roll and the magnitude of the freestream velocity can change).

Methods

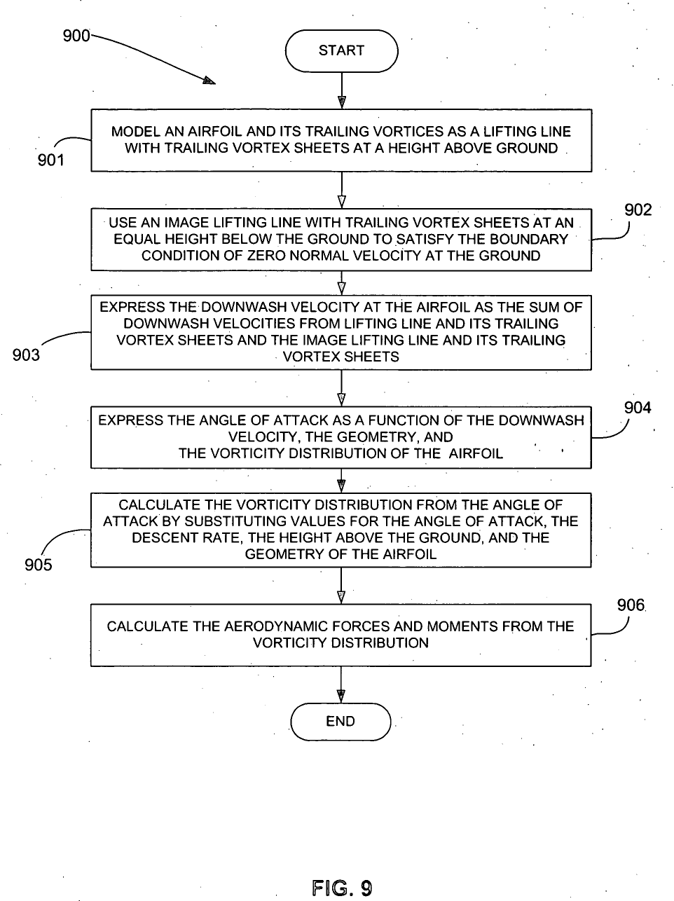

FIG. 9 is a flow chart of a method for calculating aerodynamic forces and moments on an airfoil using a modified lifting line and its image in accordance with an embodiment of the present invention. All calculations of this method can be performed on a suitably programmed computer.

In step 901 of method 900, an airfoil of a fixed wing aircraft and its trailing vortices are modeled as a lifting line with trailing vortex sheets at a certain height above the ground.

In step 902, an image lifting line with trailing vortex sheets is placed at a distance below the ground equal to the height above the ground in order to satisfy a boundary condition of zero normal velocity at the ground.

In step 903, the downwash velocity at the airfoil is expressed as a sum of the downwash velocity obtained from trailing vortex sheets above the ground and the downwash velocity obtained from the image vortex sheets below the ground. The downwash velocity obtained from the image vortex sheets is a sum of two components. The first component is induced by the image vortex sheets. The second component accounts for the relative motion of the trailing sheets' vortices with respect to the lifting line and is a function of the height above the ground and the angle of ascent or descent.

In step 904, the angle of attack of the airfoil is then expressed as a function its downwash velocity, the geometry of the airfoil, and a series representation of its vorticity distribution. The geometry of the airfoil includes but is not limited to one or more of the wingspan, chord distribution, lift-slope, and twist distribution.

In step 905, the vorticity distribution is calculated from the angle of attack by substituting values for the angle of attack, a value of descent rate into the ground, a value for the height above the ground and values for geometric parameters of the airfoil.

Finally in step 906, aerodynamic forces and moments on the airfoil are calculated from the vorticity distribution. These aerodynamic forces include but are not limited to lift and drag. The aerodynamic moments include but are not limited to pitching moment.

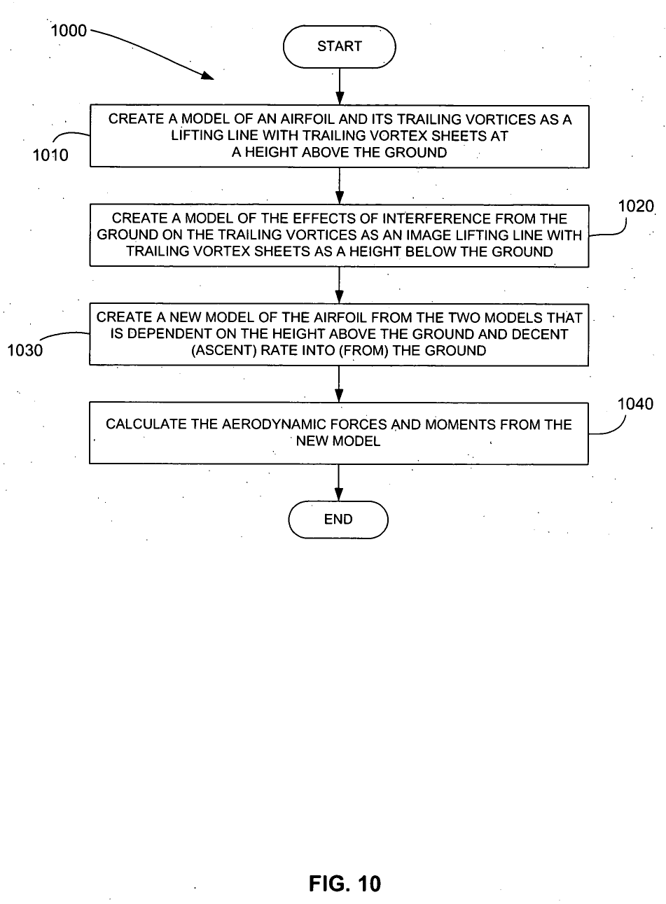

FIG. 10 is a flow chart of a method for calculating aerodynamic forces and moments on an airfoil using a modified lifting line and its image used in autoland systems, autopilot systems or computer simulations in accordance with an embodiment of the present invention. All calculations of this method can be performed on a suitably programmed computer.

In step 1010 of method 1000, an airfoil of the fixed wing aircraft and its trailing vortices are modeled as a lifting line with trailing vortex sheets at a certain height above the ground.

In step 1020, the effects of interference from the ground on the trailing vortices is modeled as an image lifting line with trailing vortex sheets at a distance below the ground equal to the height above the ground.

In step 1030, these two models are combined to create a model of the airfoil that is dependent on the height above the ground, and the angle of ascent or descent.

Finally in step 1040, aerodynamic forces and moments are then calculated from this model. These aerodynamic forces include but are not limited to lift and drag. These moments include but are not limited to the pitching moment.

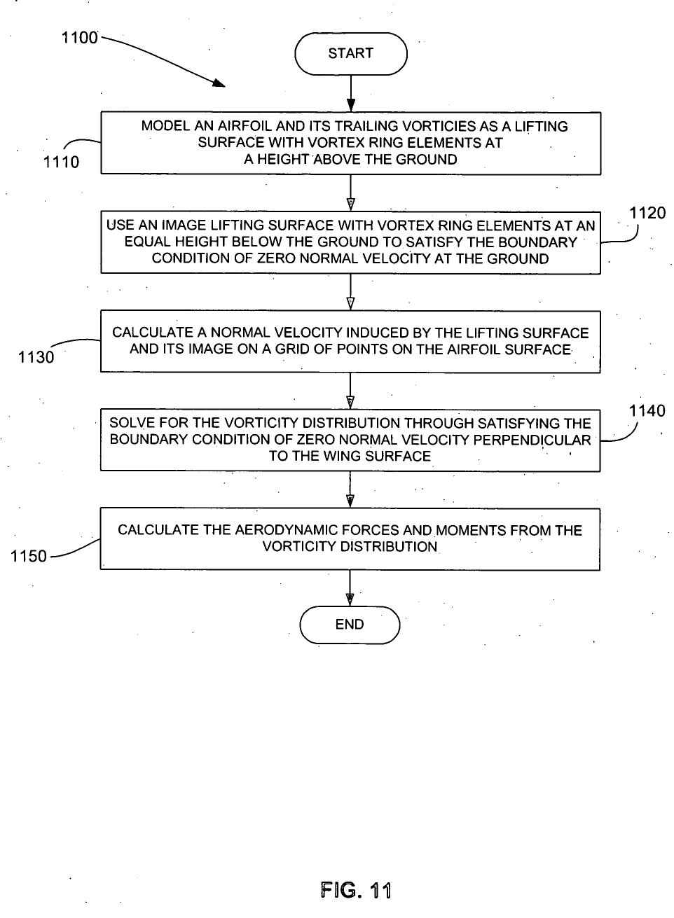

FIG. 11 is a flow chart of a method for calculating aerodynamic forces and moments on an airfoil using a lifting surface and its image in accordance with an embodiment of the present invention. All calculations of this method can be performed on a suitably programmed computer.

In step 1110 of method 1100, an airfoil and its trailing vortices are modeled as a lifting surface with vortex ring elements at a height above the ground.

In step 1120, an image lifting surface with vortex ring elements are modeled at a distance below the ground equal to the height above the ground in order to satisfy a boundary condition of zero normal velocity at the ground.

In step 1130, the normal velocity induced by the vortex ring elements and the image vortex ring elements is calculated for a grid of points on the airfoil surface.

In step 1140, a solution for the vorticity distribution is obtained by satisfying the boundary condition of zero normal velocity perpendicular to the wing surface.

In step 1150, one or more of aerodynamic forces and moments on the airfoil are calculated from the vorticity distribution. These aerodynamic forces include but are not limited to lift and drag. The aerodynamic moments include but are not limited to pitching moment.

Methods in accordance with an embodiment of the present invention disclosed herein can advantageously provide a prediction model for ground effects experienced by fixed wing aircraft that is simple enough to be incorporated into aircraft rigid body simulations and aircraft control systems. These methods can predict dynamic ground effects for fixed wing aircraft with both large and small wing aspect ratios. They also predict permit the treatment of high angles of attack through use of the experimental lift-AOA curve. Finally, these methods only need information about the wing geometry to calculate the ground effects. This information includes wingspan, chord distribution, and twist distribution.

The foregoing disclosure of the preferred embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

1. A method for calculating aerodynamic forces and aerodynamic moments of a fixed wing aircraft in proximity to ground where the altitude of the aircraft is not constant, comprising:
modeling an airfoil and its trailing vortices as a first lifting line with first trailing vortex sheets at a height above the ground;
using a second image lifting line with second trailing vortex sheets at a distance below the ground equal to the height above the ground to satisfy a boundary condition of zero normal velocity at the ground;
expressing a first velocity at the airfoil as a sum of a second velocity obtained from the first trailing vortex sheets and a third velocity obtained from the second trailing vortex sheets that is dependent on the height above the ground and at least one of angle of ascent and angle of descent;
expressing an angle of attack of the airfoil as a function of at least the first velocity, the geometry of the airfoil and a series representation of a vorticity distribution;
calculating the vorticity distribution from the angle of attack by substituting values for the angle of attack, a value for the height above the ground, at least one of a value for the angle of ascent and a value for the angle of descent, and values for the geometry of the airfoil; and
calculating one or more of the aerodynamic forces and the aerodynamic moments on the airfoil from the vorticity distribution.

2. The method of claim 1, wherein the second velocity is the sum of a first component induced by the second vortex sheet and a second component to account for the relative motion of the second trailing sheets' vortices with respect to the second lifting line.

3. The method of claim 1, wherein one or more of the aerodynamic forces comprises lift and drag.

4. The method of claim 1, wherein one or more of the aerodynamic moments comprises pitching moment.

5. The method of claim 1, further comprising estimating the aerodynamic forces and the aerodynamic moments on a tailplane by calculating a horseshoe vortex equivalent of a lifting line system and its image, estimating a at the tailplane location using equivalent vortices and their images, calculating effective angle of attack distribution at the tail, and calculating lift, drag, and moments from the angle of attack distribution.

6. The method of claim 1, wherein the geometry comprises one or more of wingspan, chord distribution, lift-slope, and twist distribution.

7. The method of claim 6, further comprising accounting for crosswind effects by using an effective chord distribution for the chord distribution and an effective lift-slope for the lift-slope.

8. The method of claim 1, further comprising adding additional vortex induced velocity terms to the first velocity to model wake vortices.

9. The method of claim 1, wherein the method is a computer-implemented method.

10. A method for calculating dynamic ground effects in fixed wing aircraft autoland systems, comprising:
creating a first model of an airfoil of the fixed wing aircraft as a first lifting line with first trailing vortex sheets at a height above the ground;
creating a second model of the effects of interference from the ground on the trailing vortices as a second image lifting line with second trailing vortex sheets at a distance below the ground equal to the height above the ground;
creating a third model of the airfoil that comprises the first model and the second model and is dependent on the height above the ground; and
calculating one or more of an aerodynamic force and a moment on the aircraft from the third model and wing geometry of the aircraft.

11. The method of claim 10, wherein the aerodynamic force comprises one or more of lift and drag.

12. The method of claim 10, wherein the aerodynamic moment comprises one or more of pitching moment.

13. The method of claim 10, wherein the method is a computer-implemented method.

14. A method for calculating dynamic ground effects in fixed wing aircraft autopilot systems, comprising:
creating a first model of an airfoil of the fixed wing aircraft as a first lifting line with first trailing vortex sheets at a height above the ground;
creating a second model of the effects of interference from the ground on the trailing vortices as a second image lifting line with second trailing vortex sheets at a distance below the ground equal to the height above the ground;
creating a third model of the airfoil that comprises the first model and the second model and is dependent on the height above the ground; and
calculating one or more of an aerodynamic force and a moment on the aircraft from the third model and wing geometry of the aircraft.

15. The method of claim 14, wherein the aerodynamic force comprises one or more of lift and drag.

16. The method of claim 14, wherein one or more of the aerodynamic moment comprises one or more of pitching moment.

17. The method of claim 14, wherein the method is a computer-implemented method.

18. A method for calculating dynamic ground effects in computer simulations of fixed wing aircraft, comprising:
creating a first model of an airfoil of the fixed wing aircraft as a first lifting line with first trailing vortex sheets at a height above the ground;
creating a second model of the effects of interference from the ground on the trailing vortices as a second image lifting line with second trailing vortex sheets at a distance below the ground equal to the height above the ground;
creating a third model of the airfoil that comprises the first model and the second model and is dependent on the height above the ground and at least one of angle of ascent and angle of descent; and
calculating one or more of an aerodynamic force and a moment on the aircraft from the third model and wing geometry of the aircraft.

19. The method of claim 18, wherein the aerodynamic force comprises one or more of lift and drag.

20. The method of claim 18, wherein the aerodynamic moment comprises one or more of pitching moment.

21. The method of claim 18, wherein the method is a computer-implemented method.

22. A method for calculating aerodynamic forces and moments on an airfoil of a fixed wing aircraft in proximity to ground where the altitude of the aircraft is not constant, comprising:
modeling the airfoil and its trailing vortices as a first lifting surface with first vortex ring elements at a height above the ground;
using a second image lifting surface with second vortex ring elements at a distance below the ground equal to the height above the ground to satisfy a boundary condition of zero normal velocity at the ground;
calculating a normal velocity induced by the first vortex ring elements and the second vortex ring elements on a grid of points on the airfoil surface;
solving for the vorticity distribution through satisfying the boundary condition of zero normal velocity perpendicular to the wing surface; and
calculating one or more of the aerodynamic forces and the moments on the airfoil from the vorticity distribution.

23. The method of claim 22, wherein one or more of the aerodynamic forces comprises lift and drag.

24. The method of claim 23, further comprising one or more of the aerodynamic moments comprises pitching moment.

25. The method of claim 23, further comprising using kinematic components in the case of unsteady flight to calculate the lift and the drag.

26. The method of claim 22, wherein the method is a computer-implemented method.
